(19) United States
(12) Patent Application Publication
(10) Pub. No.: US 2023/0098155 A1
(43) Pub. Date: Mar. 30, 2023

(54) SERVER APPARATUS, STORAGE MEDIUM, VEHICLE MANAGEMENT SYSTEM, INFORMATION PROCESSING APPARATUS, STORAGE MEDIUM, AND OPERATION MANAGEMENT METHOD

(71) Applicant: TOYOTA JIDOSHA KABUSHIKI KAISHA, Toyota-shi (JP)

(72) Inventor: Ibuki SHIMADA, Miyoshi-shi (JP)

(73) Assignee: TOYOTA JIDOSHA KABUSHIKI KAISHA, Toyota-shi (JP)

(21) Appl. No.: 17/886,589

(22) Filed: Aug. 12, 2022

(30) Foreign Application Priority Data
Sep. 27, 2021 (JP) 2021-157283

(51) Int. Cl. G06Q 10/02; G08G 1/123; G06Q 50/30

(52) U.S. Cl. CPC G06Q 10/025; G08G 1/123; G06Q 50/30

(57) ABSTRACT

A server apparatus includes a communication portion, and a controlling portion configured to perform communication by the communication portion. In a case where a first vehicle operated on a route has no vacant seat, an information processing apparatus configured to, upon receipt of passenger information on a passenger desired to board the first vehicle without reservation, output information indicative of permission of boarding when the first vehicle has a vacant seat outputs information indicative of non-permission of boarding and transmits the passenger information, and upon receipt of the passenger information, the controlling portion makes a reservation for boarding to a second vehicle in association with the passenger information.

### CROSS-REFERENCE TO RELATED APPLICATION

This application claims priority to Japanese Patent Application No. 2021-157283 filed on Sep. 27, 2021, incorporated herein by reference in its entirety.

### BACKGROUND

### 1. Technical Field

This disclosure relates to a server apparatus, a storage medium, a vehicle management system, an information processing apparatus, a storage medium, and an operation management method.

### 2. Description of Related Art

Various technologies to support the operation of a so-called semi-demand bus that operates on a route and allows a boarding-reserved passenger to board the bus have been proposed. For example, Japanese Unexamined Patent Application Publication No. 2020-52925 (JP 2020-52925 A) describes a system that achieves comfortable ride-sharing and promotes friendship between passengers registered as friends among passengers who have made a reservation in advance by inquiring the passengers registered as friends about whether or not they preferentially select ride-sharing.

### SUMMARY

There is room to make bus operation more efficient.

This disclosure provides a server apparatus and so on that can improve efficiency of bus operation.

A server apparatus according to this disclosure includes a communication portion and a controlling portion configured to perform communication by the communication portion. In a case where a first vehicle operated on a route has no vacant seat, an information processing apparatus configured to, upon receipt of passenger information on a passenger desired to board the first vehicle without reservation, output information indicative of permission of boarding when the first vehicle has a vacant seat outputs information indicative of non-permission of boarding and transmits the passenger information, and upon receipt of the passenger information, the controlling portion makes a reservation for boarding to a second vehicle in association with the passenger information.

An information processing apparatus according to this disclosure includes a communication portion, and a controlling portion configured to perform communication by the communication portion. In a case where the controlling portion receives passenger information on a passenger desired to board a first vehicle operated on a route without reservation, when the first vehicle has a vacant seat, the controlling portion outputs information indicative of permission of boarding, but when the first vehicle does not have a vacant seat, the controlling portion outputs information indicative of non-permission of boarding and transmits the passenger information to the server apparatus. Upon receipt of the passenger information, the server apparatus makes a reservation for boarding to a second vehicle in association with the passenger information.

An operation management method according to this disclosure is an operation management method for a vehicle by a system including an information processing apparatus and a server apparatus configured to communicate with each other. The vehicle operation management method includes: a step of, upon receipt of passenger information on a passenger desired to board a first vehicle operated on a route without reservation, the information processing apparatus outputting information indicative of permission of boarding when the first vehicle has a vacant seat or outputting information indicative of non-permission of boarding and transmitting the passenger information the server apparatus when the first vehicle does not have a vacant seat; and a step of, upon receipt of the passenger information, the server apparatus making a reservation for boarding to a second vehicle in association with the passenger information.

With the server apparatus and so on in this disclosure, it is possible to improve the efficiency of the operation of a bus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating an exemplary configuration of an operation management system;

FIG. 2 is a view illustrating an exemplary configuration of a server apparatus;

FIG. 3 is a view illustrating an exemplary configuration of a vehicle;

FIG. 4 is a view illustrating an exemplary configuration of an information processing apparatus;

FIG. 5 is a view illustrating an exemplary configuration of a terminal apparatus;

FIG. 6 is a sequence diagram illustrating an exemplary operation of the operation management system; and

FIG. 7 is a sequence diagram illustrating an exemplary operation of the operation management system.

### DETAILED DESCRIPTION OF EMBODIMENTS

The following describes an embodiment,

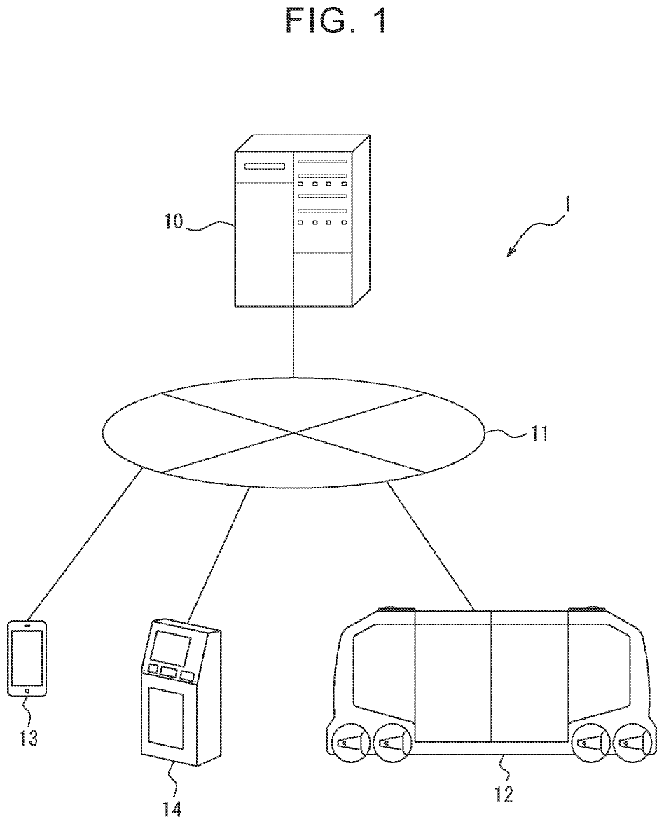

FIG. 1 is a schematic view illustrating an exemplary configuration of an operation management system according to one embodiment. The operation management system 1 is a system for supporting operation management of a bus operated on a route. The operation management system 1 includes one or more server apparatuses 10, one or more vehicles 12, and one or more information processing apparatuses 13, 14 that are connected to each other via a network 11 in an information exchangeable manner.

The server apparatus 10 is a server computer belonging to a cloud computing system or other computing systems and functioning as a server configured to implement various functions, for example. The server apparatus 10 is used by a company that provides a semi-demand bus operation service.

The vehicle 12 has a communication function and an information processing function and is connected to the network 11 via a mobile communications network. The vehicle 12 is a bus vehicle operated on a predetermined route such that a passenger can get on and off the vehicle 12 with or without reservation at a stop placed along the route. The vehicle 12 may be driven by a driver, or its operation may be automated at a given level (any level from level 1 to level 5 defined by Society of Automotive Engineers (SAE), for example). Further, the vehicle 12 may be a battery electric vehicle or a hybrid electric vehicle using electric power of a battery for at least part of energy for traveling.

The information processing apparatus 13 is an information processing apparatus having a communication function. The information processing apparatus 13 is provided in the vehicle 12 or a stop for the vehicle 12 so as to execute information processing for a passenger to board the vehicle 12, for example. The information processing apparatus 13 includes general-purpose information processing apparatuses such as a personal computer and a tablet terminal, and an exclusive information processing terminal devoted to the purpose of the present embodiment. The information processing apparatus 13 may be configured to be integrated with an apparatus such as a ticketing machine or a signage in the stop.

A terminal apparatus 14 is an information processing apparatus having a communication function and is, for example, a tablet terminal, a smartphone, or the like to be used by a passenger to make a reservation for boarding to the vehicle 12.

The network 11 is the Internet, for example, and includes an ad-hoc network, a local area network (LAN), a metropolitan area network (MAN), other networks, or any combination thereof.

In the present embodiment, the operation management system 1 supports efficiency of the operation of the vehicle 12 operated on a route. In a case where the information processing apparatus 13 receives passenger information on a passenger desired to board the vehicle 12 operated on the route without reservation, when the vehicle 12 has a vacant seat, the information processing apparatus 13 outputs information indicative of permission of boarding. In the meantime, when the vehicle 12 does not have a vacant seat, the information processing apparatus 13 outputs information indicative of non-permission of boarding and transmits the passenger information to the server apparatus 10. In response to this, the server apparatus 10 makes a reservation for boarding to another vehicle 12 in association with the passenger information. In a case where the vehicle 12 is operated with passengers who have made a reservation for boarding, if vacant seats remain vacant, opportunity loss occurs for the operation company of the vehicle 12. In order to minimize the opportunity loss, the vehicle 12 accepts boarding without reservation (hereinafter referred to as walk-in boarding). Here, the number of vacant seats in the vehicle 12 changes depending on a reserved state and the number of passengers of walk-in boarding (hereinafter referred to as walk-in passengers), and the vehicle 12 cannot accept walk-in passengers more than the number of vacant seats. In such a case, the operation management system 1 provides a reservation for another vehicle 12 to a walk-in passenger who cannot board the vehicle 12 initially requested by the walk-in passenger. This makes it possible to improve passenger's satisfaction and secure a new boarding opportunity. Thus, with the operation management system 1, a new boarding opportunity in another vehicle can be secured while the vacant seats in the vehicle 12 are filled, thereby making it possible to improve the efficiency of the operation of the vehicle 12.

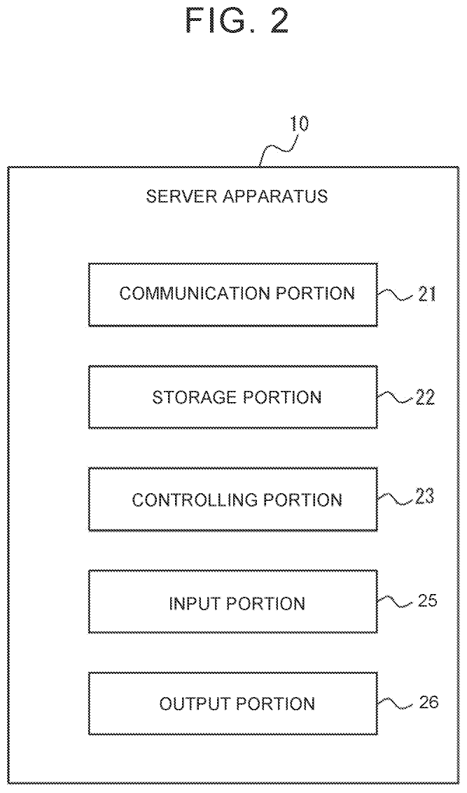

FIG. 2 is a view to describe an exemplary configuration of the server apparatus 10. The server apparatus 10 includes a communication portion 21, a storage portion 22, a controlling portion 23, an input portion 25, and an output portion 26. The server apparatus 10 is, for example, one computer. Alternatively, the server apparatus 10 may be constituted by two or more computers connected to each other in an information exchangeable manner and configured to operate in cooperation. In that case, the configuration illustrated in FIG. 2 is placed appropriately in each of the two or more computers.

The communication portion 21 includes one or more communications interfaces. The communications interface is an LAN interface, for example. The communication portion 21 receives information to be used for the operation of the server apparatus 10 and also transmits information obtained by the operation of the server apparatus 10. The server apparatus 10 is connected to the network 11 via the communication portion 21 and performs information exchange with the vehicle 12 via the network 11.

The storage portion 22 includes, for example, one or more semiconductor memories, one or more magnetic memories, or one or more optical memories each functioning as a main storage device, an auxiliary storage device, or a cache memory, or a combination of at least two types of memories from among them. The semiconductor memory is, for example, a random access memory (RAM) or a read only memory (ROM). The RAM is, for example, a static RAM (SRAM) or a dynamic RAM (DRAM). The ROM is, for example, an electrically erasable programmable ROM (EEPROM). In the storage portion 22, information to be used for the operation of the server apparatus 10 and information obtained by the operation of the server apparatus 10 are stored.

The controlling portion 23 includes one or more processors, one or more dedicated circuits, or a combination thereof. The processor is, for example, a general-purpose processor such as a central processing unit (CPU), or a dedicated processor such as a graphics processing unit (GPU) that is devoted to a specific process. The dedicated circuit is, for example, a field-programmable gate array (FPGA), an application specific integrated circuit (ASIC), or the like. The controlling portion 23 executes information processing related to the operation of the server apparatus 10 while the controlling portion 23 controls each part of the server apparatus 10.

The input portion 25 includes one or more input interfaces. The input interface is, for example, a physical key, an electrostatic capacitive key, a pointing device, a touchscreen provided integrally with a display, or a microphone for receiving voice input. The input portion 25 receives an operation to input information to be used for the operation of the server apparatus 10 and transmits the information thus input to the controlling portion 23.

The output portion 26 includes one or more output interfaces. The output interface is, for example, a display or a speaker. The display is, for example, a liquid crystal display (LCD) or an organic electroluminescence (EL) display. The output portion 26 outputs information to be obtained by the operation of the server apparatus 10.

The functions of the server apparatus 10 are implemented such that a control program is executed by the processor included in the controlling portion 23. The control program is a program to cause the computer to function as the server apparatus 10. Further, some of or all of the functions of the server apparatus 10 may be implemented by the dedicated circuit included in the controlling portion 23. Further, the control program may be stored in a non-transient recording-storage medium readable by the server apparatus 10 and may be read from the medium by the server apparatus 10.

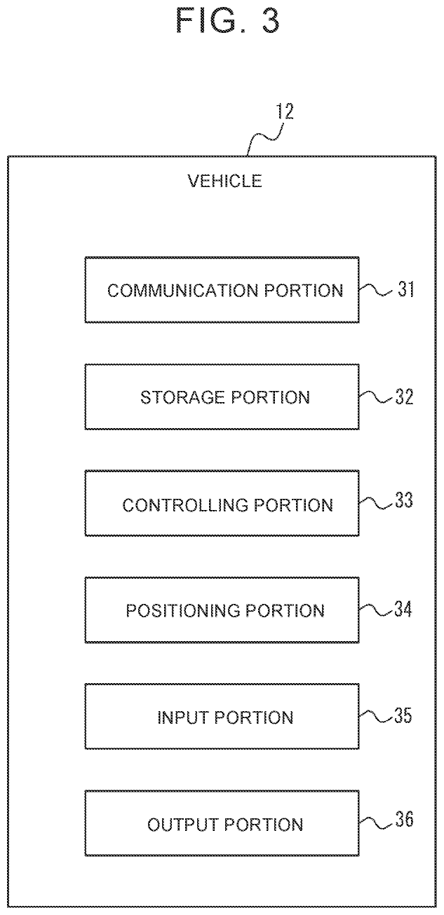

FIG. 3 illustrates an exemplary configuration of the vehicle 12 according to the present embodiment. The vehicle 12 includes a communication portion 31, a storage portion 32, a controlling portion 33, a positioning portion 34, an input portion 35, and an output portion 36. One or more of these portions may be provided as one control device or may be constituted by a personal computer including a tablet terminal, a smartphone terminal, or a navigation device. Alternatively, these portions may be connected to each other in an information exchangeable manner via an in-vehicle network in conformity with a standard such as a controller area network (CAN).

The communication portion 31 includes one or more communications interfaces. The communications interface is an interface corresponding to a mobile communications standard such as Long Term Evolution (LTE), 4th-Generation (4G), or 5th-Generation (5G), for example. The communication portion 31 receives information to be used for the operation of the controlling portion 33 and transmits information obtained by the operation of the controlling portion 33. The controlling portion 33 is connected to the network 11 via a base station for mobile communications by the communication portion 31 and performs information exchange with other apparatuses via the network 11.

The storage portion 32 includes one or more semiconductor memories, one or more magnetic memories, one or more optical memories, or a combination of at least two types of memories from among them. The semiconductor memory is a RAM or a ROM, for example. The RAM is an SRAM or a DRAM, for example. The ROM is an EEPROM, for example. The storage portion 32 functions as a main storage device, an auxiliary storage device, or a cache memory, for example. In the storage portion 32, information to be used for the operation of the controlling portion 33 and information obtained by the operation of the controlling portion 33 are stored.

The controlling portion 33 includes one or more processors, one or more dedicated circuits, or a combination thereof. The processor is a general-purpose processor such as a CPU or a dedicated processor devoted to a specific process. The dedicated communication circuit is, for example, an FPGA or an ASIC. The controlling portion 33 executes information processing related to the operation of the vehicle 12 while the controlling portion 33 controls each part of the controlling portion 33.

The positioning portion 34 includes one or more global navigation satellite system (GNSS) receivers. The GNSS includes, for example, at least any of a global positioning system (GPS), a quasi-zenith satellite system (QZSS), BeiDou, a global navigation satellite system (GLONASS), and Galileo. The positioning portion 34 acquires position information on the vehicle 12.

The input portion 35 includes one or more input interfaces. The input interface is, for example, a physical key, an electrostatic capacitive key, a pointing device, a touchscreen provided integrally with a display, or a microphone for receiving voice input. The input interface may further include a camera configured to take in a captured image or an image code, or an integrated circuit (IC) card reader. The input portion 35 receives an operation to input information to be used for the operation of the controlling portion 33 and transmits the information thus input to the controlling portion 33.

The output portion 36 includes one or more output interfaces. The output interface is, for example, a display or a speaker. The display is, for example, an LCD or an organic EL display. The output portion 36 outputs information to be obtained by the operation of the controlling portion 33.

The functions of the controlling portion 33 are implemented such that a control program is executed by the processor included in the controlling portion 33. The control program is a program to cause the processor to function as the controlling portion 33. Further, some of or all of the functions of the controlling portion 33 may be implemented by the dedicated circuit included in the controlling portion 33.

While the controlling portion 33 provides and receives various pieces of information to and from the communication portion 31, the storage portion 32, the positioning portion 34, the input portion 35, and the output portion 36, the controlling portion 33 controls these portions, and the controlling portion 33 also controls the movement of the vehicle 12. At the time when the vehicle 12 is operated, the controlling portion 33 provides various pieces of information necessary for driving to a driver via the output portion 36 or controls self-driving of the vehicle 12, and hereby, the controlling portion 33 controls the operation of the vehicle 12.

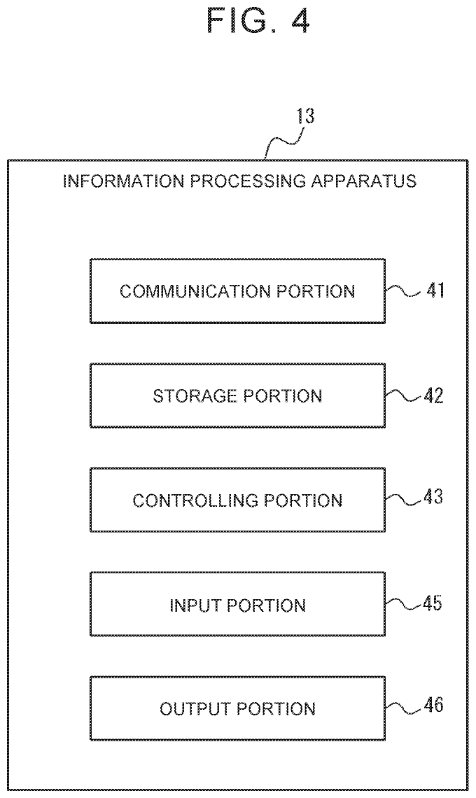

FIG. 4 is a view to describe the configuration of the information processing apparatus 13. The information processing apparatus 13 is, for example, a general-purpose information processing apparatus such as a personal computer or a tablet terminal, an exclusive information processing terminal devoted to the purpose of the present embodiment, or the like. The information processing apparatus 13 may be provided in the vehicle 12 or may be provided in a stop for the vehicle 12. The information processing apparatus 13 includes a communication portion 41, a storage portion 42, a controlling portion 43, an input portion 45, and an output portion 46.

The communication portion 41 includes a communication module corresponding to a wired or wireless LAN standard, a module corresponding to a mobile communications standard such as 4G, or 5G, or the like. The information processing apparatus 13 is connected to the network 11 via a neighboring router device or a base station for mobile communications by the communication portion 41 and performs information exchange with other apparatuses via the network 11.

The storage portion 42 includes, for example, one or more semiconductor memories, one or more magnetic memories, one or more optical memories, or a combination of at least two types of memories from among them. The semiconductor memory is a RAM or a ROM, for example. The RAM is an SRAM or a DRAM, for example. The ROM is an EEPROM, for example. The storage portion 42 functions as a main storage device, an auxiliary storage device, or a cache memory, for example. In the storage portion 42, information to be used for the operation of the controlling portion 43 and information obtained by the operation of the controlling portion 43 are stored.

The controlling portion 43 includes, for example, one or more general-purpose processors such as a CPU or a micro processing unit (MPU) or one or more dedicated processors devoted to a specific process. Alternatively, the controlling portion 43 may include one or more dedicated circuits such as an FPGA or an ASIC. The controlling portion 43 generally controls the operation of the information processing apparatus 13 by operating in accordance with a control-processing program or by operating in accordance with an operation procedure implemented as a circuit. The controlling portion 43 transmits and receives various pieces of information to and from the server apparatus 10 and so on via the communication portion 41 and executes the operation according to the present embodiment.

The input portion 45 includes one or more input interfaces. The input interface is, for example, a physical key, an electrostatic capacitive key, a pointing device, a touchscreen provided integrally with a display, or a microphone for receiving voice input. The input interface may further include a camera configured to take in a captured image or an image code, or an IC card reader. The input portion 45 receives an operation to input information to be used for the operation of the controlling portion 43 and transmits the information thus input to the controlling portion 43.

The output portion 46 includes one or more output interfaces. The output interface is, for example, a display or a speaker. The display is, for example, an LCD or an organic EL display. The output portion 46 outputs information to be obtained by the operation of the controlling portion 43.

The functions of the controlling portion 43 are implemented such that a control program is executed by the processor included in the controlling portion 43. The control program is a program to cause the processor to function as the controlling portion 43. Further, some of or all of the functions of the controlling portion 43 may be implemented by the dedicated circuit included in the controlling portion 43.

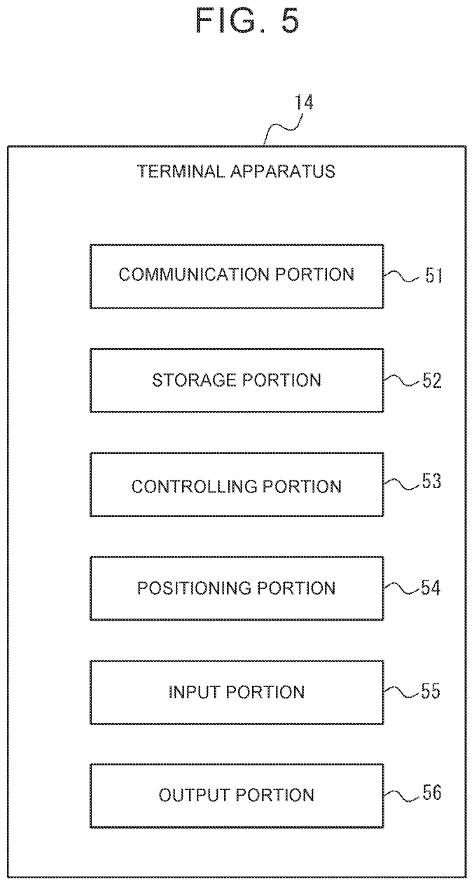

FIG. 5 is a view to describe the configuration of the terminal apparatus 14. The terminal apparatus 14 is an information processing apparatus such as a smartphone or a tablet terminal, for example. The terminal apparatus 14 includes a communication portion 51, a storage portion 52, a controlling portion 53, a positioning portion 54, an input portion 55, and an output portion 56.

The communication portion 51, the storage portion 52, the controlling portion 53, the input portion 55, and the output portion 56 have configurations equivalent to the configurations of the communication portion 41, the storage portion 42, the controlling portion 43, the input portion 45, and the output portion 46 of the information processing apparatus 13, respectively.

The positioning portion 54 includes one or more GNSS receivers. The GNSS includes at least one of a GPS, a QZSS, a GLONASS, BeiDou, and Galileo, for example. The positioning portion 44 acquires position information on the information processing apparatus 13.

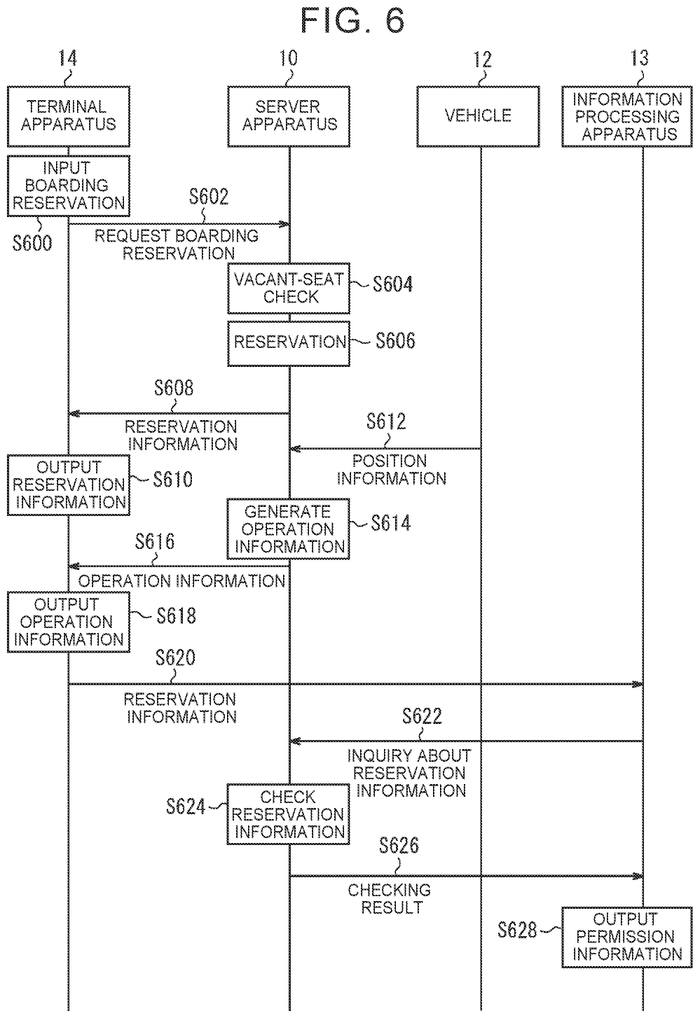

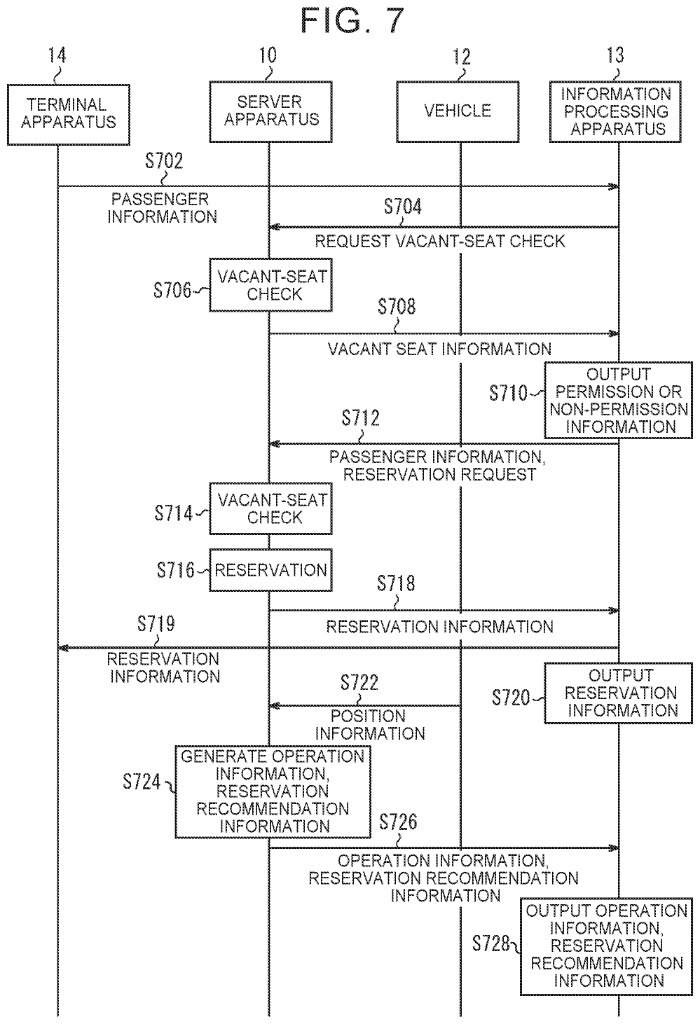

FIGS. 6, 7 are sequence diagrams to describe the operation procedure of the operation management system 1. FIGS. 6, 7 illustrate the procedure of the linked operations of the server apparatus 10, the vehicle 12, the information processing apparatus 13, and the terminal apparatus 14. Steps of respective information processings of the server apparatus 10, the vehicle 12, the information processing apparatus 13, and the terminal apparatus 14 in FIGS. 6, 7 are executed by the controlling portions 23, 33, 43, 53, respectively. Further, steps of transmission and reception of various pieces of information in the server apparatus 10, the vehicle 12, the information processing apparatus 13, and the terminal apparatus 14 are executed such that the controlling portions 23, 33, 43, 53 transmit and receive information to and from each other via the communication portions 21, 31, 41, 51, respectively. The server apparatus 10, the vehicle 12, the information processing apparatus 13, and the terminal apparatus 14 are configured such that pieces of information to be transmitted and received by the controlling portions 23, 33, 43, 53 are appropriately stored in the storage portions 22, 32, 42, 52, respectively. Further, the controlling portions 23, 33, 43, 53 receive input of various pieces of information by the input portions 25, 35, 45, 55, respectively, and output various pieces of information by the output portions 26, 36, 46, 56, respectively.

FIG, 6 illustrates the procedure at the time when a passenger boards the vehicle 12 by making a reservation for hoarding.

In step S600, the terminal apparatus 14 receives input of a boarding reservation from a passenger. The boarding reservation includes passenger information based on which the passenger is identified, and information on the number of passengers, a desired vehicle service, a stop, a desired boarding time, and so on. The controlling portion 53 displays a boarding-reservation input screen by the output portion 56 and receives information necessary for the reservation via the touch panel or the like of the input portion 45. The passenger information includes a full name, an address, the date of birth, a user registration number, and so on based on which the passenger is identified. The passenger information may be stored in advance in the storage portion 52 as user registration information.

In step S602, the terminal apparatus 14 transmits a boarding reservation request to the server apparatus 10. The boarding reservation request includes information on the input boarding reservation. The server apparatus 10 receives the information transmitted from the terminal apparatus 14.

In step S604, the server apparatus 10 makes a vacant-seat check. In the storage portion 22 of the server apparatus 10, information indicative of a reserved and vacant state for each vehicle 12 is stored. The controlling portion 23 checks vacant seats for the requested number of passengers in a vehicle specified by the reservation request. When there are vacant seats, the controlling portion 23 makes a reservation for boarding in step S606. For example, seats for the requested number of passengers among the vacant seats are reserved. The seats to be reserved may be non-assigned seats or may be assigned seats. Alternatively, the vacant seats may be a space having a volume that can accept the passengers without seats. The controlling portion 23 generates reservation information in association with the passenger information. Note that, when there is no vacant seat, the boarding reservation is not made.

In step S608, the server apparatus 10 transmits the reservation information to the terminal apparatus 14. The reservation information includes information on success or failure of the reservation, the reserved number of passengers, a vehicle for which the reservation is made, a stop, a boarding scheduled time, and so on. The terminal apparatus 14 receives the information transmitted from the server apparatus 10.

In step S610, the terminal apparatus 14 outputs the reservation information. The terminal apparatus 14 displays the reservation information by the output portion 56 to show the reservation information to the passenger. Hereby, the passenger checks the reservation. In a case where the reservation is not made, when the passenger cancels the boarding with reservation, the procedure in FIG. 6 is canceled.

In step S612, the server apparatus 10 receives position information on the vehicle 12 from the vehicle 12. For example, a plurality of vehicles 12 is configured such that the vehicles 12 transmit respective pieces of position information to the server apparatus 10 at a given cycle (e.g., every several seconds), and the server apparatus 10 extracts position information on a target vehicle 12 for reservation. Alternatively, the server apparatus 10 may request position information to the target vehicle 12 for reservation, and the target vehicle 12 may transmit its position information to the server apparatus 10 in response to the request.

In step S614, the server apparatus 10 generates operation information. The operation information includes a current position of the vehicle 12, arrival and departure estimated times at each stop on the route, and so on.

In step S616, the server apparatus 10 transmits the operation information to the terminal apparatus 14. The terminal apparatus 14 receives the information transmitted from the server apparatus 10.

In step S618, the terminal apparatus 14 outputs the operation information. The terminal apparatus 14 displays the operation information by the output portion 56 to show the operation information to the passenger. Hereby, the passenger checks the position of the vehicle 12 for which the boarding reservation is made, the time of arrival at a stop, and so on, and the passenger moves to the stop.

In step S620, the terminal apparatus 14 transmits the reservation information to the information processing apparatus 13. The passenger transmits, as information necessary for the boarding, the reservation information to the information processing apparatus 13 provided in the stop or the vehicle 12 arriving at the stop by use of the terminal apparatus 14. The terminal apparatus 14 may transmit the passenger information together with the reservation information. The information processing apparatus 13 receives the information transmitted from the terminal apparatus 14. The information from the terminal apparatus 14 to the information processing apparatus 13 is transmitted, for example, by short-distance communication, display and reading of an image, or the like.

In step S622, the information processing apparatus 13 inquires of the server apparatus 10 about the reservation information. The information processing apparatus 13 transmits the reservation information to the server apparatus 10 and inquires of the server apparatus 10 about the reservation information. The information processing apparatus 13 may transmit, to the server apparatus 10, the passenger information together with the reservation information. The server apparatus 10 receives the information transmitted from the information processing apparatus 13.

In step S624, the server apparatus 10 checks the reservation information.

The controlling portion 23 checks the reservation information received from the terminal apparatus 14 against the reservation information generated in step S606 to find whether the reservation is made or not. The controlling portion 23 may further check the passenger information associated with the reservation information.

In step S626, the server apparatus 10 transmits a checking result to the information processing apparatus 13. The checking result includes information indicative of reservation confirmation. The information processing apparatus 13 receives the information transmitted from the server apparatus 10.

In step S628, the information processing apparatus 13 outputs permission information to permit boarding. The information processing apparatus 13 outputs the permission information by the output portion 46 in response to the reservation confirmation. For example, a message indicating that boarding is permitted is output by display or voice, for example. Hereby, the passenger gets on the vehicle 12.

FIG. 7 illustrates the procedure of walk-in boarding of a walk-in passenger. The procedure of FIG. 7 is executed when a walk-in passenger is to board the vehicle 12 arriving at a stop by walk-in boarding.

In step S702, the terminal apparatus 14 transmits passenger information to the information processing apparatus 13. The passenger transmits the passenger information to the information processing apparatus 13 provided in the stop or the vehicle 12 arriving at the stop by use of the terminal apparatus 14. The passenger information includes information indicative of the requested number of passengers. The requested number of passengers may be input into the terminal apparatus 14 by the walk-in passenger or may be stored in the storage portion 42 in advance, for example. The information processing apparatus 13 receives the information transmitted from the terminal apparatus 14.

In step S704, the information processing apparatus 13 requests the server apparatus 10 to make a vacant-seat check. Even when the passenger information is transmitted from the terminal apparatus 14, the controlling portion 33 of the information processing apparatus 13 does not receive reservation information, and therefore, the controlling portion 33 determines that no reservation is made. In order to determine whether walk-in boarding is available or not, the controlling portion 33 requests the server apparatus 10 to check whether the vehicle 12 has a vacant seat or not. The passenger information and the vehicle information based on which the vehicle 12 and its operation service are identified, for example, are added to the request of the vacant-seat check. The server apparatus 10 receives the information transmitted from the information processing apparatus 13.

In step S706, the server apparatus 10 makes a vacant-seat check. The controlling portion 23 checks whether or not the specified vehicle 12 has vacant seats for the requested number of passengers. In a case where it is assumed that the destination of the walk-in passenger is unidentified, the controlling portion 23 checks vacant-seat availability over the whole course to the final destination of the vehicle 12, instead of checking current vacant-seat availability.

In step S708, the server apparatus 10 transmits vacant-seat information to the information processing apparatus 13. The vacant-seat information includes information on the vacant-seat availability, the number of vacant seats, and so on as a result of the vacant-seat check. The information processing apparatus 13 receives the information transmitted from the server apparatus 10.

In step S710, the information processing apparatus 13 outputs permission information that permits boarding or non-permission information that does not permit boarding, depending on the vacant-seat availability. When the vehicle 12 has vacant seats for the requested number of passengers, the information processing apparatus 13 outputs permission information by the output portion 46. For example, a message indicating that boarding is permitted (e.g., “Seat is available. Please board the vehicle.”) is output by display or voice. Hereby, the walk-in passenger can board the vehicle 12 by walk-in boarding. In the meantime, when the vehicle 12 does not have vacant seats for the requested number of passengers, the information processing apparatus 13 outputs non-permission information by the output portion 46. For example, a message indicating that boarding is not permitted (e.g., “No seat is available. Sorry.”) is output by display or voice. Hereby, the walk-in passenger cancels walk-in boarding to the vehicle 12.

In a case where the walk-in boarding is not permitted, the information processing apparatus 13 transmits a reservation request to the server apparatus 10 together with the passenger information in step S712. The passenger information includes information on the requested number of passengers. The server apparatus 10 receives the information transmitted from the information processing apparatus 13.

In step S714, the server apparatus 10 makes a vacant-seat check for other vehicles 12. The controlling portion 23 checks whether or not one or more subsequent vehicles 12 have vacant seats for the requested number of passengers, for example. When there are vacant seats, the controlling portion 23 makes a reservation for boarding in step S716. For example, seats for the requested number of passengers among the vacant seats are reserved. The seats to be reserved may be non-assigned seats or may be assigned seats. The controlling portion 23 generates reservation information in association with the passenger information. Note that, when there is no vacant seat, no reservation is made.

In step S718, the server apparatus 10 transmits the reservation information to the information processing apparatus 13. The reservation information includes information on success or failure of the reservation, the reserved number of passengers, a vehicle for which the reservation is made, a stop, a boarding scheduled time, and so on. The information processing apparatus 13 receives the information transmitted from the server apparatus 10.

In step S719, the information processing apparatus 13 transmits the reservation information to the terminal apparatus 14. The terminal apparatus 14 receives the information transmitted from the information processing apparatus 13.

In step S720, the information processing apparatus 13 outputs the reservation information. The information processing apparatus 13 displays the reservation information by the output portion 46 to show the reservation information to the walk-in passenger. Hereby, the walk-in passenger checks the reservation made for another vehicle. In a case where no reservation is made, information indicating that no reservation is made is output, so that the procedure of FIG. 7 is canceled.

In step S722, the server apparatus 10 receives position information on another vehicle 12 for which a boarding reservation is made from the vehicle 12. The vehicle 12 may transmit position information to the server apparatus 10 at a given cycle (e.g., every several seconds) or may transmit position information to the server apparatus 10 in response to a request from the server apparatus 10.

In step S724, the server apparatus 10 generates operation information. The operation information includes a current position of the vehicle 12, arrival and departure estimated times at each stop on the route, and so on. Further, in the server apparatus 10, a history of non-permission of walk-in boarding is stored in association with the passenger information of the walk-in passenger, and when the number of times of non-permission reaches a given reference number of times, the server apparatus 10 generates reservation recommendation information. The reservation recommendation information is information that recommends boarding with reservation,

In step S726, the server apparatus 10 transmits the operation information to the information processing apparatus 13. In a case where the server apparatus 10 generates reservation recommendation information, the server apparatus 10 further transmits the reservation recommendation information to the information processing apparatus 13. The information processing apparatus 13 receives the information transmitted from the server apparatus 10.

In step S728, the information processing apparatus 13 outputs the operation information. The information processing apparatus 13 displays the operation information by the output portion 46 to show the operation information to the walk-in passenger, Hereby, the walk-in passenger checks the position of the vehicle 12 for which the boarding reservation is made, the time of arrival at the stop, and so on. Further, in a case where the information processing apparatus 13 receives the reservation recommendation information from the server apparatus 10, the information processing apparatus 13 outputs the reservation recommendation information by display or voice. The reservation recommendation information includes, for example, a message that recommends making a reservation (e.g., “Please make a reservation next time to surely board a vehicle.”)

When another vehicle 12 for which the boarding reservation is made arrives, the walk-in passenger executes step S620 in FIG. 6 by use of the terminal apparatus 14. At this time, the terminal apparatus 14 transmits the reservation information acquired in step S719 to the information processing apparatus 13. Then, steps S622 to S628 are performed, and the walk-in passenger gets on another vehicle 12 for which the boarding reservation is made.

When the procedure of FIG. 6 or FIG. 7 is executed, and the information processing apparatus 13 outputs permission information for the boarding of the passenger with reservation or the boarding of the walk-in passenger, the information processing apparatus 13 requests the server apparatus 10 to update vacant-seat information. Upon receipt of the request, the server apparatus 10 updates vacant-seat information on each vehicle 12. Thus, the latest vacant-seat state of the vehicle 12 is grasped by the server apparatus 10 at any time.

With the abovementioned procedures, even in a case where a walk-in passenger cannot board the vehicle 12, a reservation for another vehicle 12 is provided to the walk-in passenger. This makes it possible to improve passenger's satisfaction and secure a new boarding opportunity. Thus, with the operation management system 1, while the vacant seats in the vehicle 12 are filled, a new boarding opportunity to another vehicle can be secured, thereby making it possible to improve the efficiency of the operation of the vehicle 12. Further, by outputting reservation recommendation information depending on the history of non-permission of boarding of the walk-in passenger, it is possible to secure more reliable operation of the vehicle 12.

In the above description, the information processing apparatus 13 is provided in a stop or the vehicle 12. However, the configuration and operation of the information processing apparatus 13 may be attained as appropriate by separate apparatuses provided in the stop and the vehicle 12 in a dispersed manner. In that case, the information processing apparatus 13 may be configured as a whole such that these apparatuses communicate with each other.

In the above description, the embodiment has been described based on the drawings and the examples, but it should be noted that a person skilled in the art can easily make various modifications and alterations based on this disclosure. Accordingly, it should be noted that these modifications and alterations are included in the scope of this disclosure. For example, functions and the like included in the means, the steps, and the like can be rearranged within a range where the rearrangement is not logically inconsistent with the above embodiment, and a plurality of means, steps, and the like may be combined into one or may be divided.

What is claimed is:

1. A server apparatus comprising:
a communication portion; and
a controlling portion configured to perform communication by the communication portion, wherein, in a case where a first vehicle operated on a route has no vacant seat, an information processing apparatus configured to, upon receipt of passenger information on a passenger desired to board the first vehicle without reservation, output information indicative of permission of boarding when the first vehicle has a vacant seat outputs information indicative of non-permission of boarding and transmits the passenger information, and upon receipt of the passenger information, the controlling portion makes a reservation for boarding to a second vehicle in association with the passenger information.

2. The server apparatus according to claim 1, wherein:
the controlling portion further receives, from the information processing apparatus, information indicative of the number of passengers who are not permitted to board the first vehicle and makes a reservation for boarding to the second vehicle for the number of passengers.

3. The server apparatus according to claim 1, wherein the controlling portion transmits first reservation information indicative of the reservation for boarding to the second vehicle to the information processing apparatus and causes the information processing apparatus to output the first reservation information.

4. The server apparatus according to claim 3, wherein the controlling portion further transmits operation information indicative of a position of the second vehicle to the information processing apparatus and causes the information processing apparatus to output the operation information.

5. The server apparatus according to claim 1, wherein:
the controlling portion accepts a reservation for boarding to the first vehicle from a terminal apparatus in accordance with the number of passengers or the number of vacant seats in the vehicle and transmits second reservation information indicative of the reservation for boarding to the first vehicle to the information processing apparatus; and
the information processing apparatus determines whether the passenger is desired to board the first vehicle with reservation or without reservation, based on the second reservation information.

6. The server apparatus according to claim 1, wherein:
the controlling portion transmits reservation recommendation information that recommends making a reservation to the information processing apparatus based on a history of non-permission of boarding of the passenger corresponding to the passenger information; and
the information processing apparatus outputs the reservation recommendation information.

7. A non-transitory storage medium storing a program to be executed by a computer, the program causing the computer to function as the server apparatus according to claim 1.

8. An operation management system comprising the server apparatus according to claim 1, and an information processing apparatus.

9. An information processing apparatus comprising:
a communication portion; and
a controlling portion configured to perform communication by the communication portion, wherein:
in a case where the controlling portion receives passenger information on a passenger desired to board a first vehicle operated on a route without reservation, when the first vehicle has a vacant seat, the controlling portion outputs information indicative of permission of boarding, but when the first vehicle does not have a vacant seat, the controlling portion outputs information indicative of non-permission of boarding and transmits the passenger information to the server apparatus; and
upon receipt of the passenger information, the server apparatus makes a reservation for boarding to a second vehicle in association with the passenger information.

10. The information processing apparatus according to claim 9, wherein:
the controlling portion further transmits, to the server apparatus, information indicative of the number of passengers who are not permitted to board the first vehicle; and
the server apparatus makes a reservation for boarding to the second vehicle for the number of passengers.

11. The information processing apparatus according to claim 9, wherein the controlling portion receives first reservation information indicative of the reservation for boarding to the second vehicle from the server apparatus and outputs the first reservation information.

12. The information processing apparatus according to claim 11, wherein the controlling portion further receives operation information indicative of a position of the second vehicle from the server apparatus and outputs the operation information.

13. The information processing apparatus according to claim 9, wherein:
when the server apparatus receives, from a second information processing apparatus, a reservation for boarding to the first vehicle in accordance with the number of passengers or the number of vacant seats in the first vehicle, the controlling portion receives second reservation information indicative of a reservation for boarding to the first vehicle from the server apparatus; and
the controlling portion determines whether the passenger is desired to board the first vehicle with reservation or without reservation, based on the second reservation information.

14. The information processing apparatus according to claim 9, wherein the controlling portion receives reservation recommendation information that recommends making a reservation from the server apparatus based on a history of non-permission of boarding of the passenger corresponding to the passenger information and outputs the reservation recommendation information.

15. A non-transitory storage medium storing a program to be executed by a computer, the program causing the computer to function as the information processing apparatus according to claim 9.

16. A operation management method for a vehicle by a system including an information processing apparatus and a server apparatus configured to communicate with each other, the vehicle operation management method comprising:
a step of, upon receipt of passenger information on a passenger desired to board a first vehicle operated on a route without reservation, the information processing apparatus outputting information indicative of permission of boarding when the first vehicle has a vacant seat or outputting information indicative of non-permission of boarding and transmitting the passenger information the server apparatus when the first vehicle does not have a vacant seat; and
a step of, upon receipt of the passenger information, the server apparatus making a reservation for boarding to a second vehicle in association with the passenger information.

17. The operation management method according to claim 16, further comprising:
a step of the information processing apparatus transmitting information indicative of the number of passengers who are not permitted to board the first vehicle to the server apparatus; and
a step of the server apparatus making a reservation for boarding to the second vehicle for the number of passengers.

18. The operation management method according to claim 16, further comprising:
a step of the controlling portion transmitting first reservation information indicative of the reservation for boarding to the second vehicle to the information processing apparatus; and
a step of the information processing apparatus outputting the first reservation information.

19. The operation management method according to claim 18, further comprising:
a step of the server apparatus transmitting operation information indicative of a position of the second vehicle to the information processing apparatus; and
a step of the information processing apparatus outputting the operation information.

20. The operation management method according to claim 16, further comprising:
a step of the server apparatus receiving, from a second information processing apparatus, a reservation for boarding to the first vehicle in accordance with the number of passengers or the number of vacant seats in the first vehicle and transmitting second reservation information indicative of a reservation for boarding to the first vehicle to the information processing apparatus; and
a step of the information processing apparatus determining whether the passenger is desired to board the first vehicle with reservation or without reservation, based on the second reservation information.
